(19) United States
(12) Patent Application Publication
(10) Pub. No.: US 2007/0186238 A1
(43) Pub. Date: Aug. 9, 2007

(54) METHOD AND APPARATUS FOR PRESENTING ECOMMERCE OFFERINGS USING SEAMLESS PANORAMIC STREAMING OF VIDEO DATA

(76) Inventors: Martin M. Schrager, Boca Raton, FL (US); Jeffry Robinson, Miami, FL (US)

Correspondence Address: PAUL D. BIANCO: FLEIT, KAIN, GIBBONS,;GUTMAN, BONGINI, & BIANCO P.L., 21355 EAST DIXIE HIGHWAY, SUITE 115, MIAMI, FL, 33180, US

(21) Appl. No.: 11/671,605

(22) Filed: Feb. 6, 2007

Related U.S. Application Data
(60) Provisional application No. 60/765,838, filed on Feb. 7, 2006.

(51) Int. Cl. H04N 5/445; H04N 7/10; H04N 7/025; G06F 3/00; G06F 13/00

(52) U.S. Cl. 725/35; 725/60; 725/61; 725/34

(57) ABSTRACT

A system for providing first person, streamed video data to a prospective purchaser to create a realistic shopping experience on-line, consists of or includes receiving data from a user designating a shopping area, presenting to the user video data streams of the selected area, receiving navigation commands from the user to modify the streams, creating for the user the appearance of moving through the selected area, whereby the user may select a store, and likewise receive video data streams for shopping within the store, and for selecting products.

### CROSS REFERENCE TO RELATED APPLICATION

The present application claims the benefit under 35 U.S.C. § 119(e) of U.S. Provisional Application No. 60/765,838, filed Feb. 7, 2006, the contents of which are hereby incorporated by reference.

### FIELD OF THE INVENTION

This invention relates to electronic commerce, in general, and, more specifically, to a system for providing first person, streamed video data to a prospective purchaser to create a realistic shopping experience on-line.

### BACKGROUND OF THE INVENTION

The World Wide Web and Internet, and other technological developments, in general, have created a completely new venue in which to obtain information, purchase goods and services, and interact with other network users. Accordingly, many sources of products and services have established Web sites containing information about products, services and available information. A number of commercially available software application, e.g. Web browsers, executable on conventional computer architecture, enable users to connect to the Internet and provide a graphic user interface and appropriate functionality for locating and exploring web sites. Examples of such commercially available browsers include Netscape Navigator, commercially available from America Online, Inc., or Internet Explorer, commercially available from Microsoft Corporation, Redmond, Wash., or handheld cell phone or personal digital assistant (PDA) based browsers. Websites typically comprise a server operatively coupled to the Internet, the server having one or more “pages” which may be explored by a user using the Web browser search engine application. Page based interactive presentations have enabled a whole new field of multimedia presentations. One of the most significant stumbling blocks to planning and developing effective interactive media, however, is “thinking interactively”. Experienced Web page designers use linear progressions of information—one concept to the next. The resulting effect is that most Web page based presentations lack realism and do not provide the viewer, particularly a shopper, with a presentation environment which is conducive to shopping.

By contrast, video is a widely understood medium. Video follows a linear progression that closely matches the way viewers experience the real world. Digital video has the advantage of linear progression and inherits many of the advantages of other computer-based media-annotations, links tracking, random-access, searching, etc. Using digital video, designers can create interactive multimedia presentations which are more realistic and aesthetically pleasing to a viewer particularly an on-line shopper.

It would be desirable to have an interactive multimedia presentation which is formatted as a video presentation but which utilizes all the advantages of a computer based presentation.

Accordingly, a need exists for a system that allows a shopper to view video presentations of products and locations, particularly shopping areas, to create an increased sense of realism in the on-line shopping experience.

A further need exists for a system that allows on-line shoppers to view products and offerings and to establish real time point-to-point communications with sales clerks or personnel associated with the business entity associated with the video.

### SUMMARY OF THE INVENTION

The present invention discloses a method, system and apparatus for providing a unique online shopping experience to consumers worldwide, enabling online shoppers to actually see, hear and experience the look and feel of the world's premiere shopping areas via their computers. The system presents full panoramic video images of the most famous and desirable shopping venues throughout the world, such as Madison Avenue and Fifth Avenue in New York City, Rodeo Drive in Beverly Hills, or similar shopping venues such as may be found in Los Angeles, Chicago, San Francisco, South Hampton, London, Paris, Milan, Rome, Capri, Mexico City or Rio. A network server, using a media streaming engine, presents digital videos of actual streetscapes of selected cities, with department stores, fashion boutiques, jewelry and specialty stores, restaurants, and other landmarks, just as they appear in real life. The system can also present an experience simulating shopping at an auto dealership, boat or yacht dealer, builder, or other vendor of goods or services.

Using a conventional Web browser, an on-line shopper may navigate to a given venue or street in a selected city. One effective way to locate a particular street or shopping area is to use any of the popular internet or application based mapping tools, or an internet based satellite mapping tool, such as Google Earth (http://earth.google.com/). The coordinate location data thus obtained could be advantageously passed from the mapping application or website to the present invention using means known in the art, where the system of the invention orients the user, or the user could manually enter the location thus identified into the system of the invention, and thus be oriented to the desired location.

Once located within the particular street or area, the user could then begin looking to the left or right, stopping along the way, or backtracking to a store they saw earlier, much as one would if one were there in person, all by using a pointing device or commands from a computer or PDA. If the user is carrying a PDA, such as an iPhone, cell phone, or other handheld computing device capable of displaying data in accordance with the present invention, the user could physically move to the location indicated by the present invention, and alternately begin interacting with the shopping location in reality, or continue interacting with the present invention, as desired.

Many municipalities and private locations employ real time, live video cameras for surveillance and other uses. These cameras are mounted on buildings, light posts, and other locations. The cameras, and their use for a wide variety of purposes, are becoming increasingly common. In many instances, these cameras could be employed to provide sources of video, for use in the present invention, for actual real time views adjacent to, or within, shopping areas.

Once a visitor decides to “enter” a given store, the server media engine seamlessly links to another video data stream representing the new location. The on-line shopper may panoramically view the various departments within the store, view individual items, select individual items for closer views, zoom in and out on each item, turn the item around for more complete viewing, add it to their shopping cart, purchase the selected items, all while still on-line. Viewers can also establish live, on-line audio and video conversations with store personnel throughout the shopping experience. Viewers also can have the ability to seamlessly transfer the video and audio presentations to a hand held or similar video/audio device operated by a sales associate for more realistic presentation. In other embodiments, real-time voice to voice translations of natural languages may be used to facilitate communications between a shopper and a representative from the business establishment. In some embodiments, the user may be able to arrange for international shipment of the purchased items while still on-line. In still other embodiments, multiple items within the store can be added to the shopping cart, and items from other stores can be added to the shopping cart.

According to one aspect of the present invention, a method for conducting electronic commerce transactions comprises: (a) receiving data from a user designating a geographical location selection; (b) presenting to the user a modifiable video data stream of the selected geographic location; (c) receiving navigation commands from the user to modify the video data stream; (d) presenting the modified video data stream relative to a prior video data stream, thereby creating for the user the appearance of moving through the selected geographic location; and (e) receiving data from a user designating a product selection. In one embodiment, the method further comprises the steps of enabling the user to establish a point-to-point communication connection with a vendor associated with the selected geographic location, or, completing a transaction for purchase of the product by the user. In another embodiment, the method further comprises the step of presenting to the user an audio data stream of a geographic location in conjunction with the video data stream.

### BRIEF DESCRIPTION OF TIE DRAWINGS

The above and other features, objects and advantages of the invention will be better understood by referring to the following detailed description in conjunction with the accompanying drawing in which:

FIG. 1 is a block diagram of a computer system suitable for use with the present invention;

FIG. 2 is a conceptual block diagram of a network environment in which the system of the present invention may be implemented;

FIG. 3 is a conceptual block diagram illustrating the elements of the network server and database in accordance with the present invention;

FIG. 4 is a conceptual diagram illustrating the elements of the database and file hierarchy in accordance with the present invention;

FIGS. 5A-D are still images of illustrative videos in accordance with the present invention; and

FIGS. 6A-B collectively form a flowchart illustrating the processes of delivering a presentation and completing an e-commerce transaction in accordance with the present invention.

### DETAILED DESCRIPTION OF THE INVENTION

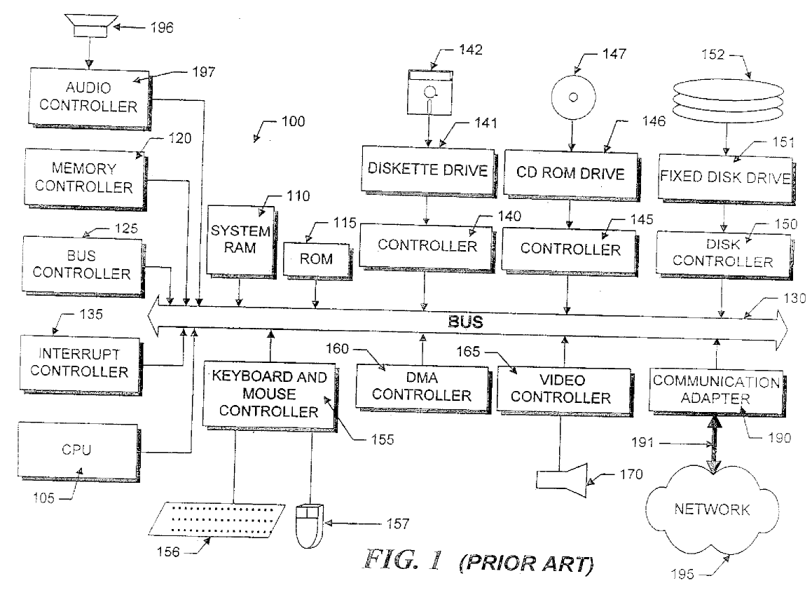

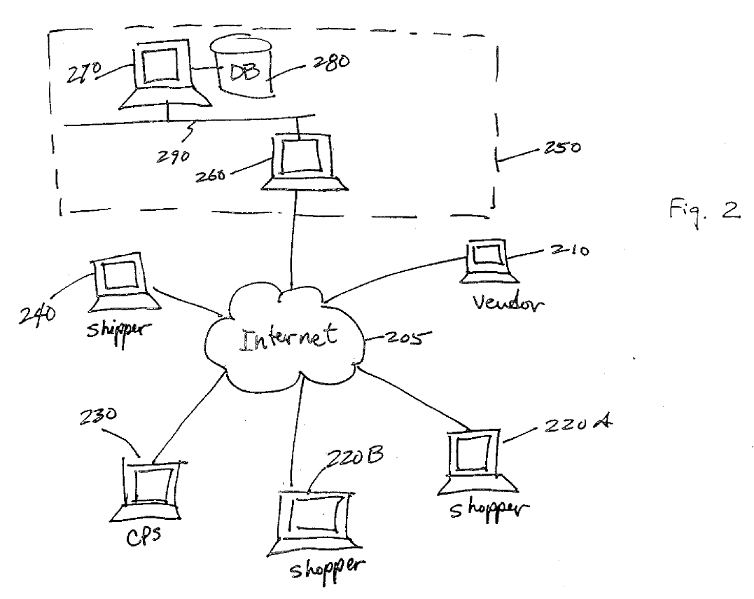

FIG. 1 illustrates the system architecture for a computer system 100 such as a server, work station or other processor on which the invention may be implemented. The exemplary computer system of FIG. 1 is for descriptive purposes only. Although the description may refer to terms commonly used in describing particular computer systems, the description and concepts equally apply to other systems, including systems having architectures dissimilar to FIG. 1.

Computer system 100 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 100. A bus controller 125 is provided for controlling bus 130. An interrupt controller 135 is used for receiving and processing various interrupt signals from the system components.

Mass storage may be provided by diskette 142, CD ROM 147, or hard drive 152. Data and software may be exchanged with computer system 100 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 100 also includes a communications adapter 190 which allows the system to be interconnected to a local area network (LAN) or a wide area network (WAN), schematically illustrated by bus 191 and network 195.

Operation of computer system 100 is generally controlled and coordinated by operating system software, such as a Windows system, commercially available from Microsoft Corp., Redmond, Wash. The operating system controls allocation of system resources and performs tasks such as processing scheduling, memory management, networking, and 1/0 services, among other things. In particular, an operating system resident in system memory and running on CPU 105 coordinates the operation of the other elements of computer system 100. The present invention may be implemented with any number of commercially available operating systems.

One or more applications such as a Web browser, for example, Netscape Navigator, Internet Explorer, or other commercially available browsers may execute under the control of the operating system.

Communication Environment

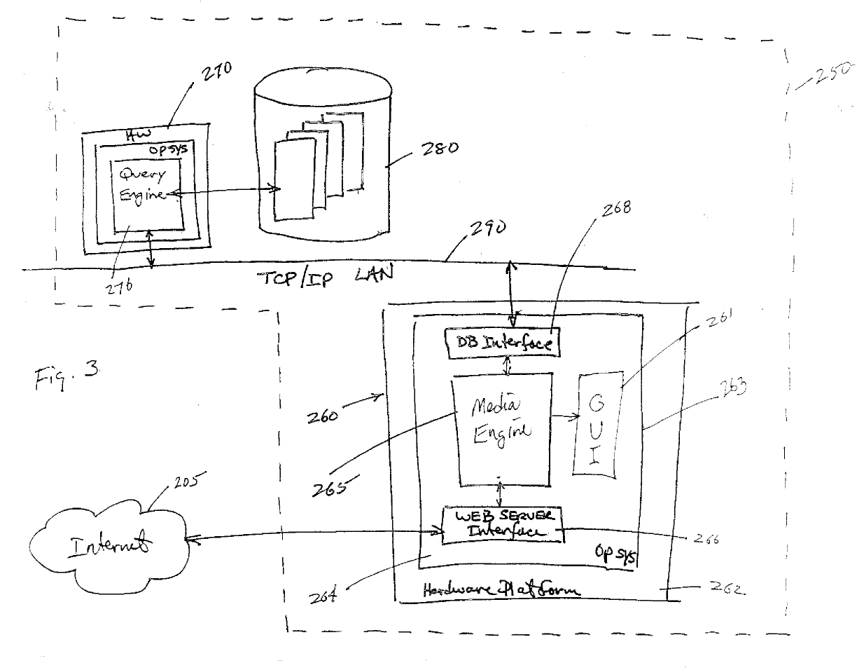

FIG. 2 illustrates a telecommunications environment in which the invention may be practiced, such environment being for exemplary purposes only and not to be considered limited. Network 200 of FIG. 2 illustrates a hybrid telecommunication environment including both a traditional circuit switched network such as a Public Switched Telephone Network, and packet-switched data networks, such as the Internet and private Intranets, as well as apparatus bridging between the two. Other means of communication, such as a voice over internet protocol (V.O.I.P.), can also be used. Not every element illustrated in FIG. 2 or described herein is necessary for the implementation of the operation of the invention.

As illustrated in FIG. 2, a global remote connection network topology, illustrated as the Internet 205, preferably including the World Wide Web, interconnects various other computers in the network environment to the inventive c-commence system 250. As will be understood by those skilled in the art, the Internet is essentially a network of networks which collectively form a global wide area network enabling processes at different network addresses, and typically in geographically disparate locations, to establish communication connections and to exchange data in a variety of formats. In the illustrative embodiment, any number of different transport protocols may be utilized between and among the various processes connectable across the Internet and private Intranets, e.g. Local Area Networks.

As illustrated in FIG. 2, in addition to inventive system 250, at least one user computer, or as shown a plurality of other computer systems 210, 220 A-B, 230, and 240 are coupled to the Internet 205. Each of these computer or internet enabled PDA systems may be implemented with a computer architecture similar or equivalent to that described with reference to FIG. 1. Computer systems 210-270 may utilize any of a number of technologies known in the arts to connect to Internet 205. For example, computer system 220A, which represents a network user, may be connected to the Internet through a dial-up connection to an Internet Service Provider, not shown, such as America Online or Compuserve. Computer system 220B, representing another network user, may alternatively be coupled to the Internet through a cable modem and broadband cable network infrastructure, also not shown. Computer system 210, representing a vendor having a Web server to which network users may connect an purchase products, may be connected to the Internet utilizing frame relay technology and a high bandwidth connection, such as a T1, T2 or T3 line. Computer system 230, representing a credit processing server, and computer system 240, representing a shipping company computer, may be similarly connected to Internet 205 using any of the previously described techniques or any other technique known in the arts.

The system 250 comprises a Web server 260, a database server 270 and database 280 operatively couple, in the illustrative embodiment, through a private network 290, e.g., a packet-switching network, such as a Local Area Network executing the TCP/IP protocol. Web server 260 is also coupled to Internet 205, for example, via a T1 line.

Alternatively, one or more of computer 210-270, may be connected to the system 250 over a broadband access network and cable provider (not shown). In such embodiment, a cable modem (CM) connects the computer to a cable node via a high frequency connection. Typically, as many as 1,000 cable modems may be connected to a cable node through appropriate cable modems and high frequency connections. Each cable node is, in turn, connected through a cable modem termination system (CMTS). A plurality of cable modem termination systems are coupled to a termination headend. A plurality of interconnected headends comprise the backbone of the broadband access network. The cable headends are typically located at the cable company facilities and may include a host data terminal connected to an Internet Protocol (IP) network through at T1 lie or other connection.

The T1 line, may be, in turn, connected to the Internet through an Internet Service Provider (ISP). The cable modem termination system converts high frequency data from a cable infrastructure into Internet Protocol format typically using the published Data Over Cable Service Industry Standard (DOCSIS). Alternatively, a network user computer may be connected to system 250 via a digital subscriber line (DSL) service (not shown). In such configuration, a user computer is coupled to a telephone company switch via a DSL modem and existing public switch telephone network infrastructure.

The construction of DST, subscriber networks and broadband access networks are known in the art and are currently used by cable companies and telephone companies extensively and will not be described in further detail here for the sake of brevity.

The above-described communication environment is for illustrative purposes only and is not meant to be limiting. The elements described herein may be operatively coupled through any combination of network configurations including, but not limited to, wide area networks, local area networks, intranets, extranets, the Internet, broadband cable networks, or any combination thereof.

Further, as used in this specification, the term t“shopper”, “user,” and “viewer” may be either a personal consumer, a business or other entity purchasing goods or services. In addition, the terms “good(s)”, “product(s)” or “item(s)” are used interchangeably.

E-comnmerce Server

Referring in FIG. 3, a conceptual block diagram of the e-commerce system 250 in accordance with the present invention is illustrated. System 250 comprises a Web server 260, a database server 270 and database 280 interconnected through a private network 290. In the illustrative embodiment, Web server 260 performs the functions of a traditional Web server enabling other processes connected to Internet 205 access to one or more Web pages on the server, serving content including web pages, video containing audio, or audio data streams. In addition, Web server 260 contains a media engine which utilizes streamed video and audio data files retrieved from database 280 to present the panoramic presentations, as described hereinafter. Web server 260 comprises a hardware platform 262 which may be implemented using a computer architecture similar to that illustrated with reference to FIG. 1. Hardware platform 262 includes a network interface for interfacing server 260 with the Internet, for example, through a T1 line. Hardware platform 262 may include an optional second interface or connecting server 260 to private network 290. Such an optional second interface may be implemented with an Ethernet LAN card or other LAN-based TCP/IP network connector. The hardware construction of such connectors and cards, as well as their appropriate drivers and protocols which implement the various transport protocol layers are well known within the art and will not be described herein in detail. Hardware platform 262 executes a computer operating system, such as a Window based system, available from Microsoft Corporation, Redmond, Wash. Such an operating system is a multi-tasking operating system capable of executing multiple simultaneous threads of execution. Execution under the control of operating system 264 is web server application 263 which comprises one or more applications necessary for Web server 260 to perform its appropriate functions. Specifically, application 263 comprises a media engine 265, a Web page interface 266, database interface 268 and graphic user interface (GUI) 261 modules. Media engine 265 interfaces with a Web page interface 266, and database interface 268 and graphic user interface 261. In the illustrative embodiment, the functions performed by media engine 265 may be implemented either with object-oriented programming techniques using the appropriate class definitions and objects for values within the database, or alternatively, using a non-object oriented language such as may be found in a UNIX environment.

Web page interface 266 functions to render, or serve, pages to users connecting to the Web server 260 and to pass dials and commands received from a user to media engine 265 through the appropriate Application Program Interfaces (APIs). In the illustrative embodiment, the Web page interface 266 may utilize a plurality of Visual Basic script files to create active Web pages. In the illustrative embodiment, such an implementation may be achieved using Microsoft's Internet Information Services Version 4.0, commercially available from Microsoft Corporation, Redmond, Wash. As will be explained herein after, media engine 265 interacts with media engine 265 and Web page interface 266 to create a web server interface which presents both streamed data and/or web paged data.

Database interface 268 functions as the interface between media engine 265, and database server 270. Database interface 268 may be implemented with the appropriate Remote Procedure Call library which enables the interface to make remote procedural calls to database server 270 and to service calls received from database server 270.

Database Architecture

Database server application 270 and database 280 comprise the system by which the database information and data files of the present invention are retrieved and stored. Specifically, database server 270 comprises a database hardware platform 272, an operating system 274 and a database query application 276. In the illustrative embodiment, hardware platform 272 is implemented with a computer system similar to that described with reference to FIG. 1. Operating system 274 may be implemented with Windows. The database query application 276 may be implemented with any number of commercially available database search query language engines, such as Microsoft SQL Server, also commercially available from Microsoft Corporation. The structure of information, including the data structure, records and various data use to access records as described hereinafter may also be designed and implemented using Microsoft SQL Server, The actual data files containing streamed video and or audio are formatted in accordance with the compression/decompression (codee) and protocols used by the media engine, as described hereinafter.

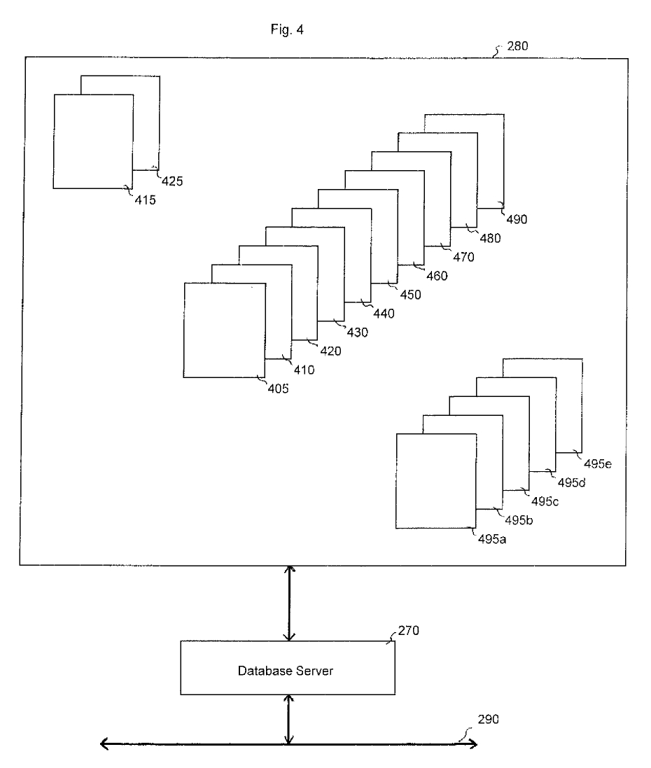

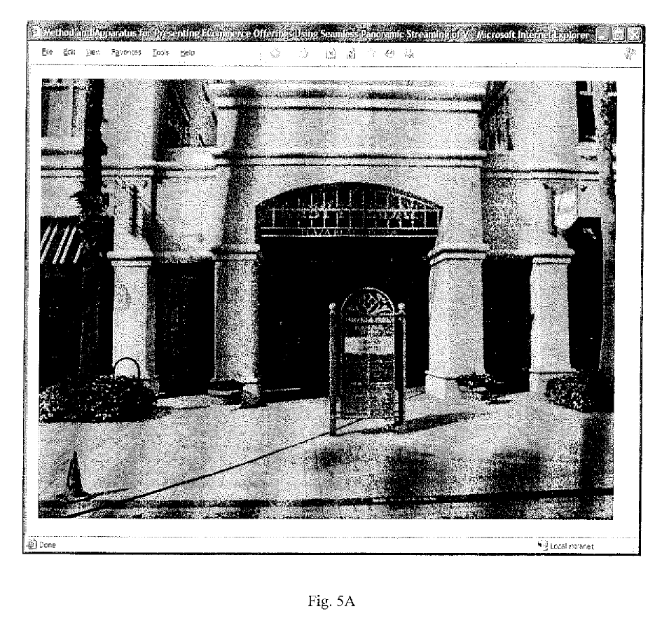

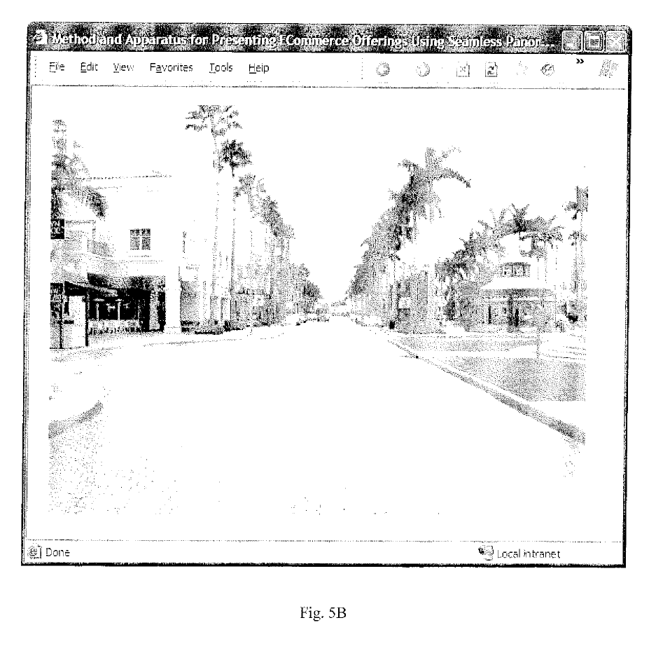

As described previously, Web server 260 and database server 270 are operatively coupled through a private network, such as a transmission Control Protocol/Internet Protocol (TCP/IP) based network. Query engine 276 receives information from Web server 260 in the form of a query and supplies the query to database 280. The structure and organization of data files within database 280 is set forth in greater detail with reference to FIG. 4. Database server 270 and database 280 may communicate using SQL standard database query language. The SQL standard is published by the American National Standards Institute (ANSI). The database engine application 276 comprises a set of objects and or code that filter the queries received from Web server 260, such filters useful in focusing or customizing the scope of a database query. The information retrieved from database 280 is forwarded by database server 270 to Web server 260 using remote procedural call libraries such as that previously described.

Referring to FIGS. 4, the arrangement of data within database 280 is illustrated conceptually. Specifically, FIG. 4A illustrates the arrangement of files 405-490 as well as the interrelationship between the various files. To further a better understanding of the architecture of database 280, the files 405-490 are described in greater detail below. In the illustrative embodiment, files 415 and 425 represent the video and audio stream data files for a particular location, such as the Plaza Real in Boca Raton, Fla., as well as linking data to other files within database 280 or elsewhere. Files 405-490 represent specific the video and audio stream data files merchant establishments which offer goods or services through the inventive system. Like files 415 and 425, files 405-490 represent the video and audio stream data as well as linking data to other files within database 280 or elsewhere, except such data relates to the store interior. Files 490A-E represent specific goods or services offered by the merchant establishment. Files 490A-E may represent the video and audio stream data of products, for example, 360 degree images a particular product such as a vase or sculpture. In addition, files 490A-E may include data about a product such as price, dimensions, product descriptions, etc.

In an alternative embodiment, files 490A-E may represent the video and audio stream data of department store areas or other subject matter about the store. In such embodiment, another layer of files, not shown in FIG. 4, would be included in the file system hierarchy of database 280 and may include the previously described product information.

Media Engine

FIG. 3 illustrates a high level block diagram of system 250 of the present invention including media engine 265. The media engine 265 uses the player/data file model similar to many other multimedia programs available. Media engine 265 may use an industry standard data streaming utility, such as QuickTime commercially available from Apple Computer Corp., Cupertino, Calif. Media engine 265 may use Quicklime for all the file input/output and for the actual display of the video and audio information to a user interface 261, in conjunction with operating system 264. In the illustrative embodiment, media engine 265 may be implemented as an application using object oriented technology and is intended to execute in a multitasking, multi-threaded environment, such as that provided by Windows.

Media engine 265 may rely upon the QuickTime codec from Apple Computer, Cupertino, Calif. as its media streaming utility, to present the audio and video data using standard functionality which is already fully documented in the QuickTime API documentation. If media engine 265 utilizes the QuickTime codec the data files may have a format similar to a QuickTime data file format. It will be obvious to those skilled in the relevant arts that other players may be used in place of the QuickTime utility. For example, the Microsoft Media Player engine, commercially available from Microsoft Corp., Redmond, Wash. Alternatively, any media engine that complies with any of MPEG, MPEG-2, QuickTime, AVI and similar standard may also be used in media engine 265. Commercially available applications suitable for use as media engine 265 are Total View, commercially available from Be Here Corporation, Fremont, Calif. and the Discourse Player, commercially available from Ideal Conditions, Inc., Boca Raton, Fla.

The format of the data within video and audio data files in database 280 is compatible with the respective media engine. Such data files contain the sound, video, still graphics, transcript, annotations, and other media types that can be included in a presentation. If the media engine 265 is implemented with the Discourse Player, commercially available from Ideal Conditions, Inc, the presented data stream may include selectable hot buttons (regions) within the video presentation, as well as relevant links through which a viewer can navigate to/from other data stream or data types and pages.

User Interface

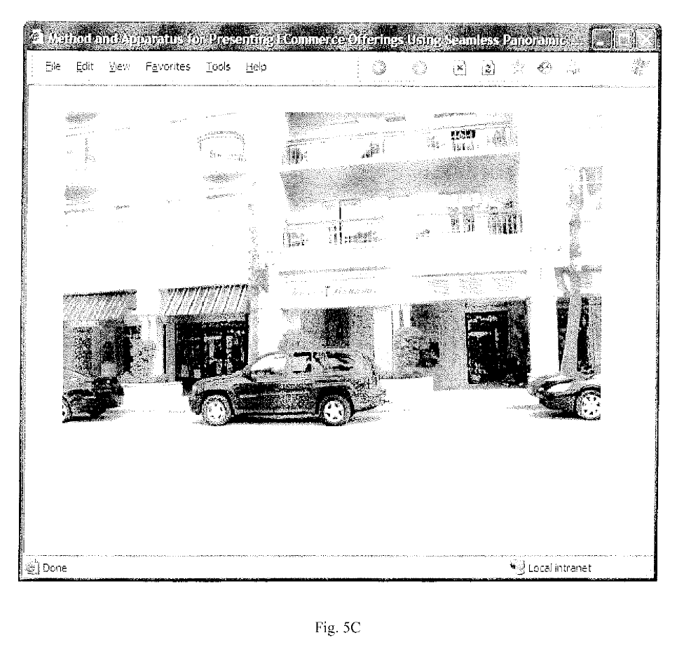

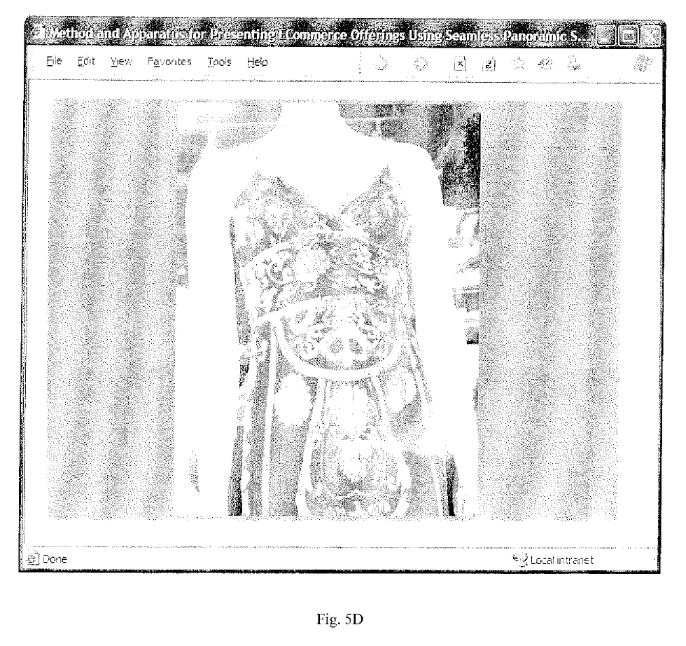

The GUI 261 presents a main window to the user. Other windows may be dynamically generated as requested by user commands. Each of these windows can be hidden or displayed, enabled or disabled, and moved around the screen at the discretion of either the user or the creator. FIGS. 5A-D illustrate an exemplary main presentation windows of a user interface presented by system 260. The user interface may be designed to obey the standard user interface guidelines of the native operating systems and one or more browser window framing capabilities.

The main window shows the presentation itself The size of this window is variable, depending on capabilities of the network user's playback hardware.

By using a pointing device, such as a mouse or a joy stick, the user is able to direct the presentation to anywhere within a wide angle perspective of the subject matter. Alternatively, a toolbar (not shown) containing control buttons may be provided enable the user to direct playback of the presentation. In some embodiments, where panoramic footage of a location was taken the streamed video may have complete 360 degree perspective. In other embodiments, where wide angle footage of a location was taken the streamed video may have 180 degree perspective. To achieve this technique panoramic analog video of street scenes are digitized and merged seamlessly through overlapping frames. The position of the cursor within the viewing field is passed to the server, which detects the user's navigation and, preferably, cooperative with the user's computer, automatically causes the current stream to be adjusted within the frame boundaries of the main presentation window or to link from the current video stream to another video stream of adjacent view, changing the video with no apparent interruption to the viewer.

Users can also click on ‘hotspots’ within the video area itself, where the clicked selection is detected by the server. These hotspots can be linked to the next adjacent level in the presentation, i.e. changing a store area, selecting a store to enter or leave, from a street scene, including navigating through the material, selecting one or more items within the store, controlling visibility of windows, or launching external resources, such as an Internet telephone application. In some embodiments the main window may provide a map or position indicator indicating where a user has progressed within a given location.

A control on GUI 261 enables the viewer to accelerate the speed with which the streamed video data are presented to the viewer in relation to the default speed. In the contemplated embodiment some video stream will be presented at walking speed while other are presented at driving speed.

Process Flow

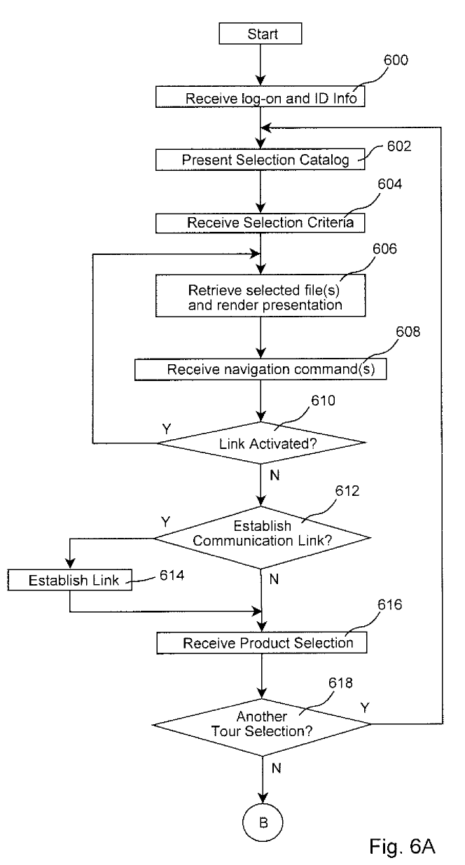

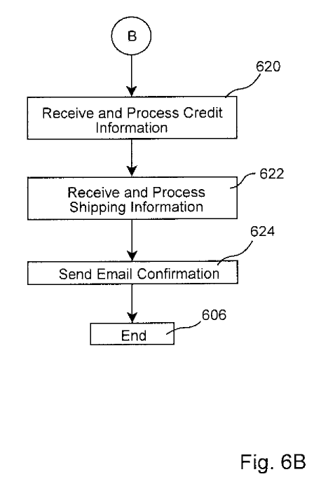

FIGS. 5A-D are screen captures of the graphic user interface of the inventive server in accordance with the present invention. FIGS. 6A-B collectively form a flowchart illustrating the processes of delivering a presentation and completing an c-commerce transaction in accordance with the present invention. First, a network user connects from his or her computer 220A or 220B through the Internet 205 to the inventive system 250, specifically Web server 260, and provides identification or other log-on information, as illustrated by step 600. A user may interact with system 250 using any currently known user interface, including pointing devices, voice recognition input, etc., which the user's system supports. The user will be greeted with a home page which offers a selection of specific shopping areas to tour, as illustrated by step 602. Once the viewer has selected a specific shopping area tour presentation, he or she will activate the link to this specific shopping area to begin the virtual shopping tour, as illustrated by step 604. The file containing the selected video stream and its related linking data, ate then retrieved from database 280 and supplied to media engine 265 for presentation through GUI 261, as illustrated by step 606. For illustrative purposes only, assume the viewer has selected Mizner Park in Boca Raton, Fla. The first page delivered to the viewer will include video of the Plaza Real at Mizner Park in Boca Raton, Fla., as illustrated in FIG. 5A.

By using a mouse or other command input device, the viewer can control the direction (video stream content) and advance along the Plaza Real at his or her own pace, enjoying the sights and sounds along the way. For example, from the image shown in FIG. 5A, moving the cursor right, beyond a predefined threshold, will automatically active a new selection link, causing the current video stream file to link to a second video stream file, as shown in FIG. 5B. The linking of the video stream is preferably done in a seamless manner which will create the perspective of turning one's head. Such an illusion may be achieved using wide angle video footage which had been digitized and, for example, overlapping frames of the previous and currently selected video stream during the transition from a first stream to a second. The process of linking from the current video stream to a new video stream is designated in FIG. 6, by process step 608 and decisional step 610. The file containing the new video stream and its related linking data, are then retrieved from database 280 and supplied to media engine 265 for presentation through GUI 261, similar to steps 606 and 608. Note that a link may also be activated by selection of a “hot spot”, i.e. a designated region within the main presentation window, as explained hereinafter. Note that a link may be resolved into web page data, in the case of a static menu, a URI, to another address, or other data types which are not necessarily streamed.

The video stream may be accompanied by an audio data stream, as well. The audio data stream may include, for example, ambient sounds recorded simultaneously with the video from which the video stream was derived. Alternatively, other audio data, such as music, a narrative monologue or any combination thereof, may be synchronized to accompany the video stream. The synchronization of the audio data stream to the video data stream may be achieved using techniques well known in the art. Preferably, when the speed of the video changes or pauses, the audio stream will remain without apparent shifts in frequency,

As shown in FIG. 5B, the viewer may advance along the Plaza Real experiencing the sites and sounds of the street scene from a first person perspective. Because the original video footage from which the video data stream was derived was made with either a wide angle or panoramic camera, not all of the data stream may be viewable within the framed window of the user's browser. Accordingly, slight movement of the cursor to the right or the left will first cause a shift in the viewing boundaries of the current stream, as illustrated in FIG. 5C, which illustrates a portion of the same video stream as FIG. 5B, before linking to another video stream is triggered, such as by movement of the cursor to the extreme window border. Preferably, sequentially linked or selected videos contain content which is spatially related, for a more continuous and realistic visual experience during the transition from one video to the next. The process of linking from one stream to another may occur in any pattern and for any duration, the only limitations being the amount of data which can be streamed within a given period. In a preferred embodiment, a data stream can be automatically linked with another stream by default, such as when the viewer reaches a dead end street or the end of a particular shopping area.

When a store or other establishment of particular interest catches the viewer interest, the visitor activates a region of the video, i.e. a “hot spot” which links the current video stream of the street and store front to a video stream representing the store interior, as illustrated by FIG. 5D, enabling the viewer to see images of the store's wares, possibly accompanied by a list of particular products for sale. In one embodiment of the invention, the interior of the store may be one or more still images, especially for a small store with a limited product selection. For larger business establishments, the interior of the store may have numerous departments and/or floors. In such instances the interior of the store may be viewable via one or more streamed audio and video files in a manner similar to that previously described with reference to the street scenes.

When the visitor begins to examine a selected store's product line, he or she will be able to click on a visual image of products for sale with supporting text. The viewer will be able in many cases to manipulate the image of a chosen product to examine the item thoroughly (e.g., zoom in, side view, etc.). In order to properly inform its viewers, affiliated vendors will provide full descriptions or each of their products in data base 280, including available sizes and colors, as well as pricing and delivery information, and return policy. In an alternate embodiment, a viewer may be able to link from Web server 260 to vendor Web server 210 of FIG. 2. The process of linking and retrieving data related to products, regardless of the type of data, is also represented in FIG. 6, by steps 606-610.

As explained hereinafter, if a viewer/user wishes to speak to a sales representative or other person to render assistance with product selection, the user may establish a real-time, point-to-point communication link with an actual sales assistant at the store or an on-line sales operator associated with an automatic call center linked to either system 250 or to a vendor web site, as illustrated by decisional step 612 and process step 614.

When the viewer wants to purchase an item from a particular store, a “shopping cart” utility within web server 260 allows customers to designate a selected item as one they wish to purchase, as represented by steps 616. The implementation of a “shopping cart” utility is within the scope of those skilled in the arts. Thereafter the user may continue shopping, either in the same store, or other stores in the same neighborhood, or even stores in other cities, as represented by decisional step 618, and the whole or part of the process may be repeated in accordance with steps 602-616.

A “checkout feature” within Web server 260 will then calculate the total amount due and receive credit card or payment information which can be processed and cleared through any number of commercially available on-line credit processing services, shown as credit processing server 230 of FIG.2, and step 620. In the event that the purchaser and the seller are in different countries, Web server 260 may connect to a shipping company offering on-line quotation and shipping services, in order to provide a quote to the viewer which includes shipping, duties, and tariffs for the consumer, as illustrated by step 622. Such services are commercially available from From2.com, Inc. of Miami, Fla. and enable a purchaser to pay for and set up international shipment of purchased goods. In the contemplated embodiment, Web server 260 also calculates amounts owed to the given vendors, as well as the transaction fees owed for facilitating store purchases via system 250.

Finally, following completion of the users shopping tour, receipts and confirmation of purchase and/or shipping arrangements may be sent to the user via email or regular postal service, as illustrated by step 624.

Viewer/ Vendor Communications

In an alternative embodiment of the invention, viewers may establish a real-time point-to-point communication link with an actual sales assistant at the store or an on-line sales operator associated with an automatic call center linked to either system 250 or the vendor. In such an embodiment live online communication between site viewers and sales associates at affiliated vendors' stores equipped with laptop computers, microphones and small hand held digital cameras may take place. Using this service, viewers would be able to interact more directly with merchants, having their questions about particular products answered immediately, as if they were in the store themselves. Such comprehensive support would ensure that questions about specific items are answered properly by store or company personnel and that all items ordered are delivered as promised in satisfactory condition. Such on-line communications would also give viewers a shop-by-appointment option.

Internet telephony applications suitable for use with system 250 include V.O.I.P. and the WebPhone or the Mini WebPhone client software application commercially available from NetSpeak Corporation, Boca Raton, Fla., referred to hereafter as the WebPhone client or WebPhone process. The WebPhone and Mini WebPhone applications can be launched from an icon on the viewer's browser and are capable of transmitting both packetized audio and video data over packet-switched networks such as the Internet. The WebPhone client process, upon instruction from the user or automatically upon receipt of the address information from browser process, attempts to establish a direct, point-to-point communication with a destination specified by the address information. If the address information is an Internet protocol address, having the form XXX.XXX.XXX, the WebPhone client process will attempt to establish a call directly to WebPhone client process at the vendor's establishment or a call center. Once established, the parties to the call can use any of the features of the WebPhone application, such as call conferencing, video displays, white boarding, etc. Alternatively, rather that calling a store directly, the viewer's call may be directed to an on-line automatic call center (ACD), such as that described in U.S. Pat. No. 5,999,965, entitled Automatic Call Distribution Server For Computer Telephony Communications. Alternatively, the viewer's call may be directed to an Interactive Voice Response (IVR) system which may be used to answer the viewer's questions while in queue for a sales representative. The WebPhone application allows parties to-exchange URT.'s with the packetized voice and video data, thereby allowing a sales representative and potential shopper to view Web pages of Web server 260 or another web site in synchronization.

In addition, the user could connect to the internet using an Apple iPhone, available from Apple, Inc., Cupertino, Calif., or other internet enabled PDA or PDA cell phone, such as the Palm Treo, manufactured by Palm, Inc., Sunnyvale, Calif. Once an internet connection is established, the user may use the invention as further described herein.

Natural Language Variations

Upon connecting to the home page of web server 260 viewer will be prompted as to which natural language he or she wishes for the presentation. Accordingly, all legend prompts, instructions and spoken words in the audio stream will be adjusted according to the user's selection. The implementation of such multilingual Web pages is currently in common use and is within the scope of those skilled in the art.

In addition it is also contemplated that the real-time voice communications established between a viewer and a vendor's sales representative be translated as necessary, in a voice to voice manner.

### Alternative Embodiments

A number of variations to the basic process and configuration of system 250 may be implemented to provide additional functionality, as set Forth herein.

Visitors to Web site 260 can request direct shopping assistance from a “Company Personal Shopper.” If assistance is requested by a user, a “Company Personal Shopper” can take limited control of the Viewers Internet connection and with the Viewers consent, lead the Viewer to specific sites around the US or the world. As an example, if a Viewer requests assistance in locating a particular type of clothing;, or accessory or special gift item, or painting or antique, a “Company Personal Shopper”, with knowledge of retailers or boutiques on the web site 260, sitting in a remote Call Center, can physically take the Viewer on a trip to various Web sites that would carry the desired items. Because this service is offered by request only this would obviate privacy issues and would be an added convenience to the Shopper and would enhance the personalized Experience for the Shopper. This is a desirable convenience for the Viewer that can bring many more visitors to the Company's Website, especially if the Viewer is new to the Web and is unsure of Web navigation or wants to save time or has a definite and specific item in mind and doesn't want to 'shop” or use a search engine.

Once personal relationships are developed, the store or the Personal Shopper can E-mail particular or targeted customers messages of when items of special interest will be available or when the store will be having its next sale. The E-mail message can either be in the form of the traditional text message or in the form of a personalized audio or audio/video e-mail message. For example, for frequent shoppers via system 250, special services such as express checkout service, discounts based on purchase levels, and exclusive previews of new fashions and products, may be offered. Such frequent users may be updated regularly via e-mail, based on their customized shopping profiles, of important sales occurring at stores of its affiliated vendors.

If after having taken the virtual tour of a particular street several times the Viewer may want to visit only one or two locations on that street. Using a site search engine, the user can either click on a map of the street, or enter the name or address of the location in the Web sites Search Engine to go directly to the most relevant files.

As part of system 250, a secure server may record credit card information one time only, allowing the Viewer to shop all over the world without ever having to enter the credit card member again. Once the viewer stores credit card information or is a “member” the credit card information (and other personal information) would be in database 280 and would never be necessary again to complete a sale. If the viewer uses the Voice Recognition Option to access the Website, the speech authentication and voice recognition software will identify and authenticate the Visitor based on their voice print. It may no longer be necessary to use passwords and PINs.

Street scenes will change regularly to reflect both seasonal and inventory/ changes and to keep the experience “fresh”. The experience can further be changed to be more reflective of the location. As an example, in the South Beach area and other Miami shopping destinations the flavor of the experience could have an international flair.

Viewers will be able to speak in English, Spanish, French, German, Italian, Portuguese, Chinese and Japanese to communicate with sales associates for merchandise description and other things of interest. Sales associates, speaking their own language, will be understood by the viewer in their own native language. Language translation software will eventually enable viewers to communicate with boutiques and Personal Shoppers whose languages may be different than their own.

The above-described invention may be implemented in either all software, all hardware, or a combination of hardware and software, including program code stored in firmware format to support dedicated hardware. A software implementation of the above described embodiment(s) may comprise a series of computer instructions either fixed on a tangible medium, such as a computer readable media, e.g. diskette 142, CD-ROM 147, ROM 115, or fixed disk 152 of FIG. 1, or transmittable to a computer system in a carrier wave, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions whether contained in a tangible medium or a carrier wave embodies all or part of the functionality previously described herein with respect to the invention. Those skilled in the art will appreciate that such computer instructions can be written in a number of programming languages for use with many computer architectures or operating systems and may exist in machine executable format. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results. The specific configuration of components or processes to achieve a particular function, as well as other modifications to the implementations of the inventive are intended to be covered by the appended claims.

What is claimed is:

1. In a computer server apparatus operatively coupled over a computer network to one or more users, a method for conducting electronic commerce transactions comprising:
(a) receiving data from a user designating a geographical location selection;
(b) presenting to the user a modifiable video data stream of the selected geographic location;
(c) receiving navigation commands from the user to modify the video data stream;
(d) presenting the modified video data stream relative to a prior video data stream, thereby creating for the user the appearance of moving through the selected geographic location; and
(e) receiving data from a user designating a product selection.

2. The method of claim 1 further comprising the step of:
(f) completing a transaction for purchase of the product.

3. The method of claim 1 further comprising the step of,
(f) enabling the user to establish a point-to-point communication connection with a vendor associated with the selected geographic location.

4. The method of claim 1 wherein step (b) further comprises:
(b. 1) presenting to the user an audio data stream of a selected geographic location in conjunction with the video data stream.

5. A method for shopping comprising:
(a) establishing a remote connection with at least one server computer from at least one user computer;
(b) serving to said at least one user computer a video depicting an area containing at least one store;
(c) detecting a selection from said at least one user computer of a store depicted on said video;
(d) serving to said at least one user computer at least one series of images depicting at least one item offered in said selected store.

6. The method of claim 5, further comprising:
(e) changing said video depicting at least one store area in response to navigation on said at least one user computer.

7. The method of claim 6, further comprising:
(f) selecting said changed video from among other videos depicting an area containing at least one store, wherein sequentially selected videos contain content which is spatially related.

8. The method of claim 5, wherein said series of images comprise a video.

9. The method of claim 5, further comprising:
(e) detecting a selection from said at least one user computer of at least one item from said series of images.

10. The method of claim 9, further comprising:
(f) conducting a sales transaction with said at least one user computer or said at least one item selected by said at least one user computer.

11. The method of claim 5, wherein said remote connection is an Internet connection.

12. The method of claim 11, wherein said Internet connection includes the World Wide Web.

13. The method of claim 12, wherein said computer is a handheld computer.

14. A system for shopping, comprising:
at least one server computer;
means for remotely connecting said at least one server computer to at least one user computer;
means operative with said at least one server computer for sending said at least one user computer a video depicting an area containing at least one store;
means operative with said at least one server computer responsive to said at least one user computer for selecting a store depicted on said video;
means operative with said at least one server computer for sending said at least one user computer at least one series of images depicting at least one item offered in said selected store.

15. The system of claim 14, further comprising means for changing said video depicting at least one store area in response to navigation on said at least one user computer.

16. The system of claim 14, further comprising means for selecting said changed video from among other videos depicting an area containing at least one store, wherein sequentially selected videos contain content which is spatially related.

17. The system of claim 14, wherein said series of images comprise a video.

18. The system of claim 14, further comprising means for detecting a selection from said at least one user computer of at least one item from said series of images.

19. The system of claim 16, further comprising means for conducting a sales transaction with said at least one user computer, for said at least one item selected by said at least one computer.

20. The system of claim 14, wherein said remote connection is an Internet connection,
